(19) United States
(12) Patent Application Publication
(10) Pub. No.: US 2024/0406347 A1
(43) Pub. Date: Dec. 5, 2024

(54) VIDEOCONFERENCING DEVICE PROVIDING VIEWING ANGLE DIVERSITY

(71) Applicant: Shure Acquisition Holdings, Inc., Niles, IL (US)

(72) Inventors: Sanjay Navinchandra Kadiwala, Roselle, IL (US); Luis Angel Guerra, Miami Shores, FL (US); Brent Robert Shumard, Mount Prospect, IL (US); Zachery L. Barnett, Park Ridge, IL (US)

(21) Appl. No.: 18/732,090

(22) Filed: Jun. 3, 2024

Related U.S. Application Data
(60) Provisional application No. 63/506,174, filed on Jun. 5, 2023.
(60) Provisional application No. 63/506,065, filed on Jun. 3, 2023.

(51) Int. Cl. H04N 7/15; H04N 7/14

(52) U.S. Cl. CPC H04N 7/15; H04N 7/147

(57) ABSTRACT

A videoconferencing device may include an elongated housing having two ends, a microphone array, one or more loudspeakers, and a plurality of cameras, where at least one of the cameras is disposed at one end of the housing at least another of the cameras is disposed at an opposite end of the housing. The videoconferencing device may also include a microphone array disposed within an acoustical cavity, where the cameras and loudspeakers are disposed outside of the acoustical cavity. The videoconferencing devices may provide viewing angle diversity of the cameras to better capture images and/or video of participants in a videoconference, and also provide more optimal audio capture of the participants.

### CROSS-REFERENCE

This application claims priority to U.S. Provisional Patent Application No. 63/506,065, filed on Jun. 3, 2023, and to U.S. Provisional Patent Application No. 63/506,174, filed on Jun. 5, 2023, each of which is incorporated by reference herein.

### TECHNICAL FIELD

This application generally relates to videoconferencing technology. More specifically, this application relates to videoconferencing devices that include cameras or imaging apparatuses, a microphone array, and a loudspeaker.

### BACKGROUND

Videoconferencing devices conventionally include a single camera or cluster of cameras at a single location. However, this point of view can result in images and/or video of videoconferencing participants not being optimally captured and displayed to a far end during a videoconference. For example, the cameras may not be able to ideally capture particular participants in an environment due to non-optimal angles from the cameras to those participants' locations and/or due to those participants being obscured by other participants or objects. In addition, microphones in typical videoconferencing devices may not optimally capture the audio of videoconferencing participants due to, for example, the use of non-ideal microphone types, non-optimal microphone locations or acoustic cavities, and/or undesirable acoustic coupling with loudspeakers.

Accordingly, there is an opportunity for videoconferencing devices that address these concerns. More particularly, there is an opportunity for systems and methods that can more optimally capture images, video, and/or audio of videoconferencing participants in an environment.

### SUMMARY

The invention is intended to solve the above-noted problems by providing videoconferencing systems and methods that are designed to, among other things: (1) provide viewing angle diversity of cameras to better capture images and/or video of participants, and (2) provide more optimal audio capture of participants by a microphone array in an acoustical cavity.

In an embodiment, a videoconferencing device may include an elongated housing comprising a first end and a second end opposite of the first end, a microphone array, one or more loudspeakers, and a plurality of cameras. At least one camera of the plurality of cameras may be disposed at the first end of the housing and at least another camera of the plurality of cameras may be disposed at the second end of the housing.

In another embodiment, a videoconferencing device may include a microphone array disposed within an acoustical cavity, at least one camera disposed outside of the acoustical cavity, and at least one loudspeaker disposed outside of the acoustical cavity.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is an isometric view of an example of the disclosure having four cameras.

FIG. 2 is an isometric view of an example of the disclosure having four cameras.

FIG. 3 is an isometric view of an example of the disclosure having three cameras.

FIG. 4 is a block diagram of an example of an image collection, processing, and transmission system for a disclosed videobar.

FIG. 5 is a block diagram of an example of an image collection, processing, and transmission system for a disclosed videobar.

FIG. 6 is a block diagram of an example of an image collection, processing, and transmission system for a disclosed videobar.

FIG. 7 is a diagram showing a conventional videobar with a centrally-mounted camera in an example videoconferencing environment.

FIG. 8 is a diagram showing an example of the disclosed videobar in an example videoconferencing environment.

FIGS. 9 and 10 are diagrams showing an example of the disclosed videobar in an example videoconferencing environment and illustrating some advantages of having cameras at the ends of the videobar.

FIG. 11 illustrates another example of the disclosed videobar in an example videoconferencing environment.

FIG. 12 illustrates another example of the disclosed videobar in an example videoconferencing environment.

FIG. 13 is a front view of an example of the disclosure having four cameras.

FIG. 14 is an isometric view of an example of the disclosure having four cameras.

FIG. 15 is a block diagram of an example of an image collection, processing, and transmission system for a disclosed videobar.

FIG. 16 is a block diagram of an example of an image collection, processing, and transmission system for a disclosed videobar.

FIG. 17 is a block diagram of an example of an image collection, processing, and transmission system for a disclosed videobar.

FIG. 18 is a diagram showing an example of the disclosed videobar in an example videoconferencing environment.

FIGS. 19 and 20 are diagrams showing an example of the disclosed videobar in an example videoconferencing environment and illustrating some advantages of having cameras at the ends of the videobar.

### DETAILED DESCRIPTION

To facilitate an understanding of the principals and features of the disclosed technology, illustrative examples are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

Referring now to the Figures, in which like reference numerals represent like parts, various embodiments of the computing devices and methods will be disclosed in detail.

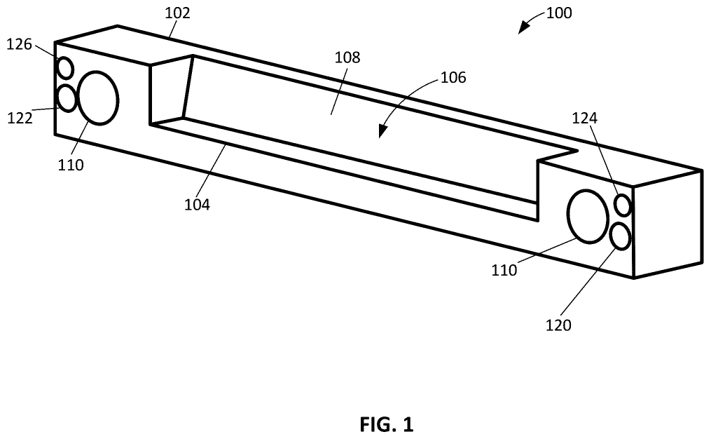

FIG. 1 is an isometric view of one example of the disclosure, including a videobar 100 having an elongated housing 102. The videobar 100 may also include a microphone array 104 positioned within a cavity 106 which may have an angled back plane 108. The microphone array 104 may be positioned in the center of the videobar 100. In this example, the videobar 100 may also include two loudspeakers 110 and four cameras 120, 122, 124, 126. In this example, two cameras 120, 124 may be located at one end of the videobar 100, and two cameras 122, 126 may be located at the opposite end of the videobar 100. In one example, cameras 120 and 122 may be a first type of camera, and cameras 124 and 126 may be a second type of camera. In another example, all of the cameras 120, 122, 124, 126 may be of the same type but oriented in different directions. In another example, the cameras 120, 122, 124, 126 may be different types and oriented in different directions.

In embodiments, the microphone array 104 may be a linear array. More specifically, the microphone array 104 may be a one-dimensional array microphone with improved directivity as described in U.S. Pat. App. Pub. No. 2022/0337946 and U.S. Pat. No. 11,750,972, each of which is hereby incorporated by reference herein. As described in those publications, the microphone array 104 may: (1) provide a one-dimensional form factor that has added directivity, for most, if not all, frequencies, in dimensions that, conventionally, have equal sensitivity in all directions; (2) achieve the added directivity by placing a row of first microphones along a first axis, and for each first microphone, placing one or more additional microphones along a second axis orthogonal to the first microphone so as to form a plurality of microphone sets, and by configuring each microphone set to cover one or more of the desired octaves for the one-dimensional array microphone; (3) provide an audio output that utilizes a beamforming pattern selected based on a direction of arrival of the sound waves captured by the microphones in the array, the selected beamforming pattern providing increased rear rejection and steering control; and (4) have high performance characteristics suitable for conferencing environments, including consistent directionality at different frequency ranges, high signal-to-noise ratio (SNR), and wideband audio coverage.

In some examples, it may be more ideal to have a clear air path to the entire surface of the one-dimensional array microphone with improved directivity, in order to maintain optimal performance. This may be difficult to achieve in certain mounting configurations of a videobar with particular positionings of a microphone array, including but not limited to: (1) a microphone array positioned on the top of the videobar when the videobar is mounted under a monitor; (2) a microphone array positioned on the bottom of the videobar when the videobar is mounted above a monitor; and (3) a microphone array positioned on the bottom of the videobar when the videobar is mounted on the top of a piece of furniture (e.g., a credenza or table).

In embodiments, placing the microphone array 104 in a fixed cavity 106 may enable control of the acoustic pathway to be maintained regardless of how the videobar 100 is mounted. While FIG. 1 shows the cavity 106 with an upward opening, it is possible and contemplated for the cavity 106 and its opening to be in any suitable orientation (e.g., downward). Moreover, while FIG. 1 shows that the cavity 106 and its opening is generally the same size as the microphone array 104, it is also possible and contemplated for the cavity 106 and its opening to be of any suitable size. For example, the size of the cavity 106 and/or its opening may be scaled to the size of the microphone array 104, in some embodiments. Controlling the acoustic environment in these manners may allow for proper tailoring of the beamformer for the acoustic conditions and allow for consistent behavior of the microphone array 104 in any mounting scheme of the videobar 100.

In some examples, it may be advantageous for the cavity 106 to have a rear cavity wall 108 that is slanted to minimize the reflective impact of the cavity 106 on certain frequencies. In addition, mounting the microphone array 104 behind the front plane of the videobar 100 may minimize coupling with the loudspeakers 110.

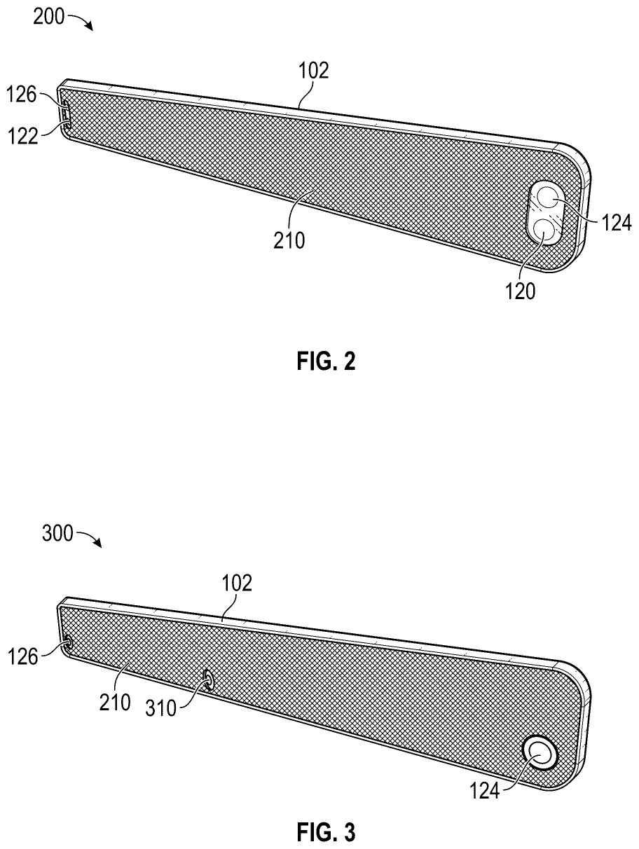

FIG. 2 is an isometric view of another example of the disclosure. In this example, a videobar 200 may include an elongated housing 102 and an acoustically transparent cover 210 that conceals and protects the microphone array 104 and its cavity 106, as well as the loudspeakers 110. The videobar 200 may have four cameras 120, 122, 124, 126, where two of the cameras 120, 124 are located at one end and two of the cameras 122, 126 are located at the other end. FIG. 3 is an isometric view of a further example of the disclosure. The videobar 300 may also include an elongated housing 102 and an acoustically transparent cover 210 that conceals and protects the microphone array 104 and its cavity 106, as well as the loudspeakers 110. The videobar 300 may have three cameras 124, 126, 310, where camera 124 is located at one end, camera 126 is located at the other end, and camera 310 is located at the center of the videobar 300. In one example, the center camera 310 may have a wider field of view than the end cameras 124, 126 in order to capture an entire room while the end cameras 124, 126 may have a narrower and/or directed field of view. In other examples, the cameras 124, 126, 310 may be of the same type, e.g., have the same field of view.

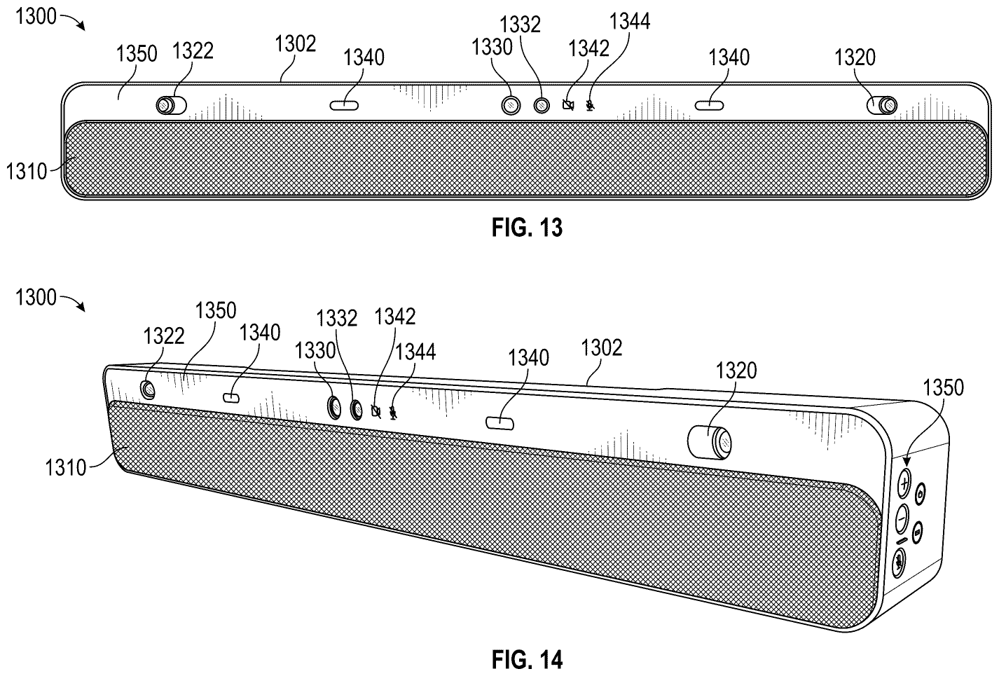

FIGS. 13 and 14 are a front view and an isometric view of another example of the disclosure, respectively. In these examples, a videobar 1300 may include an elongated housing 1302 and an acoustically transparent cover 1310 that conceals and protects the microphone array 104 and its cavity 106, as well as the loudspeakers 110. The videobar 1300 may have four cameras, 1320, 1322, 1330, 1332, where camera 1320 is located at one end, camera 1322 is located at the other end, and cameras 1330, 1332 are located at the center of the videobar 1300. The cameras 1320, 1322, 1330, 1332 may be located in a bezel 1350 of the videobar 1300, as shown in FIGS. 13 and 14. In embodiments, the cameras 1320, 1322 on the ends of the videobar 1300 and the center camera 1330 may have telephoto lenses, and the center camera 1332 may have a wide angle lens. In addition, the cameras 1320, 1322 on the ends of the videobar 1300 may be mounted 30 degrees inward towards the center of the videobar 1300, for example.

The videobar 1300 may also include indicators, such as status lights 1340 (e.g., to show that the videobar 1300 is connected to a videoconference), camera on/off indicator 1342, and microphone muting indicator 1344. Various controls 1350 may also be included on the videobar 1300, such as buttons to control power, loudspeaker volume, microphone muting, camera state, device pairing, etc. Although not shown in FIGS. 13 and 14, the microphone array 104 of the videobar 1300 may be located beneath the bezel 1350 such that the cavity 106 and its opening are oriented downwardly.

Many types of cameras can be used in the disclosed videobars 100, 200, 300, 1300. The videobars 100, 200, 300, 1300 may have multiple cameras of the same type or multiple types of cameras, in various embodiments. It is possible and contemplated that the cameras 120, 122, 124, 126, 310, 1320, 1322, 1330, 1332 may have the same or different view angles, the same or different pixel densities, the same or different focal lengths, optical and/or digital zoom functions, and/or be electromechanically actuated to change their look direction. Furthermore, it should be appreciated that the particular number of cameras (e.g., end cameras and/or center cameras), loudspeakers, and array microphones shown and described in the disclosed videobars are merely exemplary, and that any number of cameras, loudspeakers, and array microphones are possible and contemplated. As used herein, “camera” may refer to any component used to capture image data, whether static or dynamic (e.g., video), including any type of digital imagers regardless of the presence or absence of any kind of optical lens or lenses.

The videobars 100, 200, 300, 1300 may be configured to perform various image-processing functions. These functions may include digitally focusing and/or zooming on videoconference participants, “stitching” views from different cameras together, and/or producing multiple video and/or image feeds from a single camera. These functions may be achieved using commercially-available techniques or may require novel techniques in view of the novel features of the disclosure.

Depending on the type of camera used, the pixel density and frame rate of a camera's imager and the corresponding data rate of the video and/or image data produced by the camera may be such that physical limitations on the size of the videobar 100, 200, 300, 1300 may be imposed, due to commonly available data-bus types not being able to support the required bandwidth over the distance needed. The cameras 120, 122, 124, 126, 310, 1320, 1330, 1332 may generate video and/or image data in any suitable format or standard, including Camera Serial Interface (CSI) (e.g., CSI-1, CSI-2, and/or CSI-3), Display Serial Interface (DSI), and/or D-PHY, as specified by the Mobile Industry Processor Interface (MIPI) Alliance, for example.

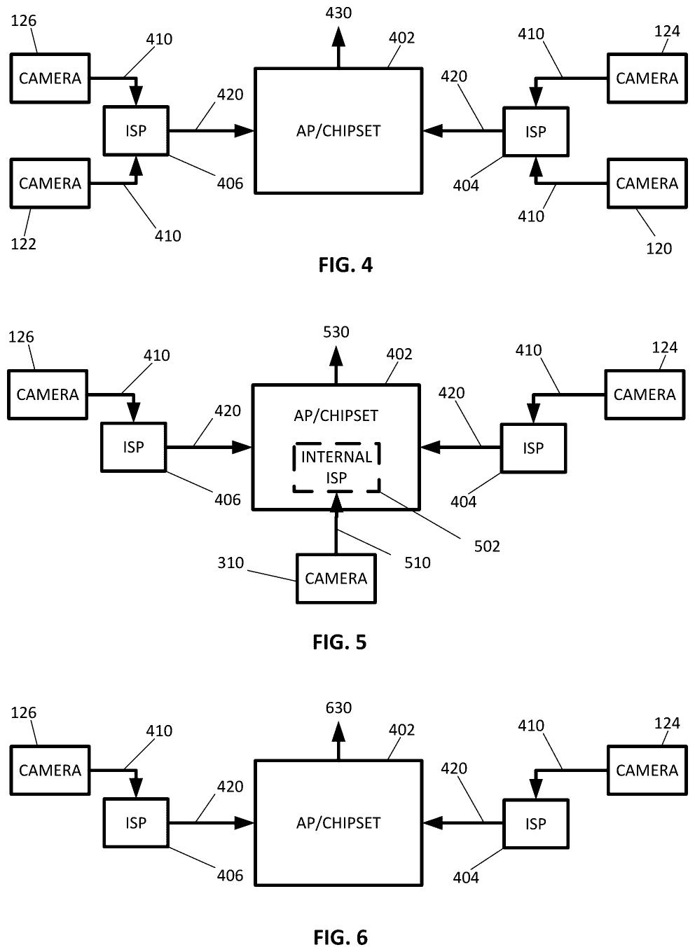

In embodiments, such as shown in FIGS. 4-6, one or more image signal processors (ISPs) may be located in physical proximity to one or more of the cameras 120, 122, 124, 126, 310, 1320, 1330, 1332 to transform the raw data (e.g., video and/or image data feed) from the cameras 120, 122, 124, 126, 310, 1320, 1330, 1332 into a format better suited to longer transmission distances, such as in the High-Definition Multimedia Interface (HDMI) format or another suitable format. For example, videobar 100, 200, 300, 1300 may have a central chipset 402 that performs functions such as input/output and processing of audio, video, and/or image signals. It may be desirable for such a chipset to be located close to the center of the videobar 100, 200, 300, 1300. However, incorporating a longer linear microphone array (e.g., microphone array 104) between the cameras 120, 122, 124, 126, 310, 1320, 1330, 1332 may produce better quality audio but may also cause the distance from the cameras 120, 122, 124, 126, 310, 1320, 1330, 1332 to the central chipset 402 to be too far to timely transmit the raw data (e.g., CSI, DSI, and/or D-PHY) to the central chipset 402, when using a conventional data bus.

FIG. 4 is a block diagram of one example of an image collection, processing, and transmission system for a disclosed videobar. In this example, the videobar may have four cameras 120, 122, 124, 126, with two of the cameras located at each end of the videobar. As described above, the central chipset 402 may be centrally located and two ISPs 404, 406 may be located proximate to the cameras at each end of the videobar. In particular, an ISP 404 may be located at one end of the videobar proximate to cameras 120 and 124, and an ISP 406 may be located at the opposite end of the videobar proximate to cameras 122 and 126. The cameras 120, 122, 124, 126 may transmit raw data 410 to the ISPs 404, 406 and the ISPs 404, 406 may convert the raw data 410 into a different image data format 420, which may be transmitted to the central chipset 402. The central chipset 402 may perform additional video and/or image processing as needed and provides a final output 430.

FIG. 5 is a block diagram of another example of an image collection, processing, and transmission system for a videobar. In this example, the videobar may have a camera 124 located at one end, a camera 126 located at an opposite end, and a centrally-located camera 310. The end cameras 124, 126 may have a proximately located ISP 404, 406, respectively. However, the centrally-located camera 310 may be physically close enough to the central chipset 402 that the need for a separate ISP can be avoided. The centrally-located camera 310 can thus transmit its raw data 510 directly to the central chipset 402. In this example, the raw data 510 of the centrally-located camera 310 may be processed by an internal ISP 502 of the central chipset 402, and may be hardware-based, software-based, or a combination of the two. The central chipset 402 may perform additional video and/or image processing as needed and provides a final output 530.

FIG. 6 is a block diagram of another example of an image collection, processing, and transmission system for a videobar. In this example, the videobar may have a camera 124 located at one end and a camera 126 located at an opposite end. The end cameras 124, 126 may each have a proximately located ISP 404, 406, respectively. The central chipset 402 may perform additional video and/or image processing as needed and provides a final output 630.

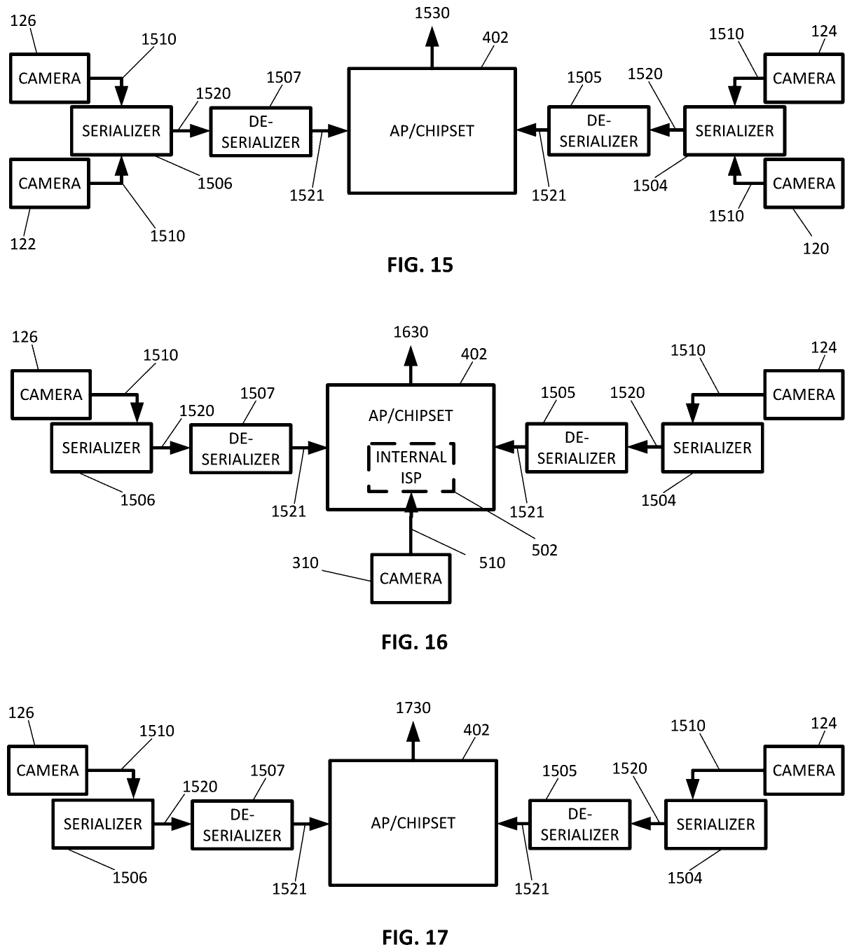

In other embodiments, such as shown in FIGS. 15-17, the raw data (e.g., video and/or image data feed) from the cameras 120, 122, 124, 126, 310, 1320, 1330, 1332 may be transformed into a format better suited to longer transmission distances, e.g., serial data, such as by using a serializer paired with a deserializer, or using any other suitable processor or SerDes (serializer/deserializer) mechanism. The serial data may be transmitted over one or more differential pairs (e.g., lanes), in some examples. A serializer may be located in physical proximity to one or more of the cameras 120, 122, 124, 126, 310, 1320, 1330, 1332, which may convert its raw data into serial data to be transmitted to a deserializer that is located in physical proximity to the central chipset 402. The serial data from the serializer may be transmitted over a printed circuit board trace to the deserializer, for example, or via another suitable conductor. The deserializer may convert the serial data generated by the serializer into video and/or image data for use by the central chipset 402. The video and/or image data generated by the deserializer may be in the same format or a different format as the video and/or image data generated by the cameras. As examples, the serializer may be the THCV241A serializer and the deserializer may be the THCV242A deserializer, both manufactured by THine Electronics, Inc. of Tokyo, Japan.

FIG. 15 is a block diagram of one example of an image collection, processing, and transmission system for a disclosed videobar. In this example, the videobar may have four cameras 120, 122, 124, 126, with two of the cameras located at each end of the videobar. The central chipset 402 may be centrally located, serializers 1504, 1506 may be located proximate to the cameras at each end of the videobar, and deserializers 1505, 1507 may be located proximate to the central chipset 402. In particular, serializer 1504 may be located at one end of the videobar proximate to cameras 120 and 124, and serializer 1506 may be located at the opposite end of the videobar proximate to cameras 122 and 126. The cameras 120, 122, 124, 126 may transmit raw data 1510 to the serializers 1504, 1506 and the serializers 1504, 1506 may convert the raw data 1510 into serial data 1520, which may be transmitted to the deserializers 1505, 1507. The deserializers 1505, 1507 may convert the serial data 1520 into data 1521. The central chipset 402 may perform additional video and/or image processing on the data 1521 as needed and provides a final output 1530.

FIG. 16 is a block diagram of another example of an image collection, processing, and transmission system for a videobar. In this example, the videobar may have a camera 124 located at one end, a camera 126 located at an opposite end, and a centrally-located camera 310. The end cameras 124, 126 may have a proximately located serializer 1504, 1506, respectively. However, the centrally-located camera 310 may be physically close enough to the central chipset 402 that the need for a separate ISP can be avoided. The centrally-located camera 310 can thus transmit its raw data 510 directly to the central chipset 402. In this example, the raw data 510 of the centrally-located camera 310 may be processed by an internal ISP 502 of the central chipset 402, and may be hardware-based, software-based, or a combination of the two. The central chipset 402 may perform additional video and/or image processing as needed and provides a final output 1630.

FIG. 17 is a block diagram of another example of an image collection, processing, and transmission system for a videobar. In this example, the videobar may have a camera 124 located at one end and a camera 126 located at an opposite end. The end cameras 124, 126 may each have a proximately located serializer 1504, 1506, respectively. The central chipset 402 may perform additional video and/or image processing as needed and provides a final output 1730.

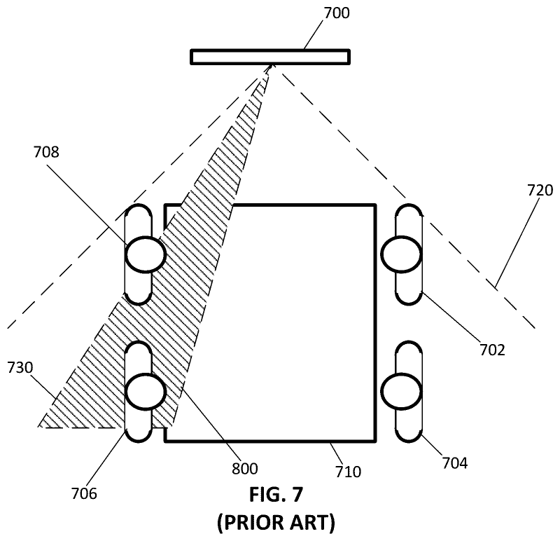

FIG. 7 is a diagram showing a conventional videobar 700 with a centrally-located camera in an example videoconferencing environment. The environment may include four local participants 702, 704, 706, 708 that are seated around a table 710. The camera of the videobar 700 may have a field of view 720 that has its extent indicated by the dotted lines in FIG. 7. As illustrated by the shaded portion 730 within the field of view 720, an image of participant 706 from the centrally-located camera may be partially obscured by participant 708. The view of the participants from a single camera may also be obscured by other obstructions, such as columns or furniture in the environment.

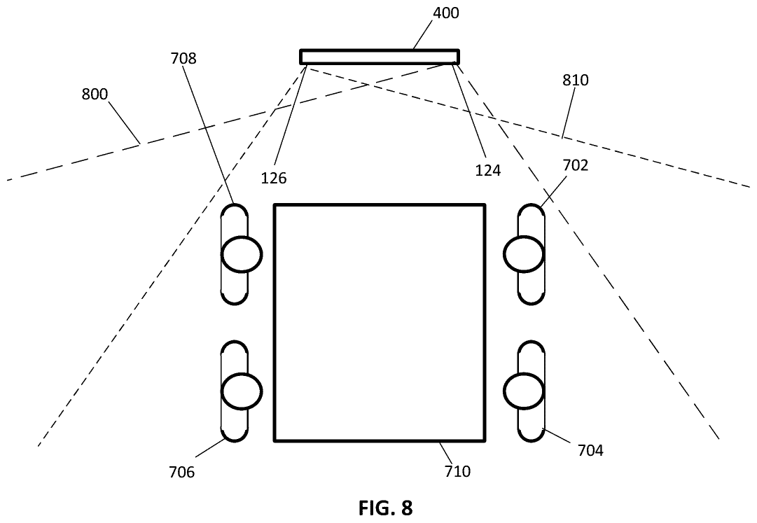

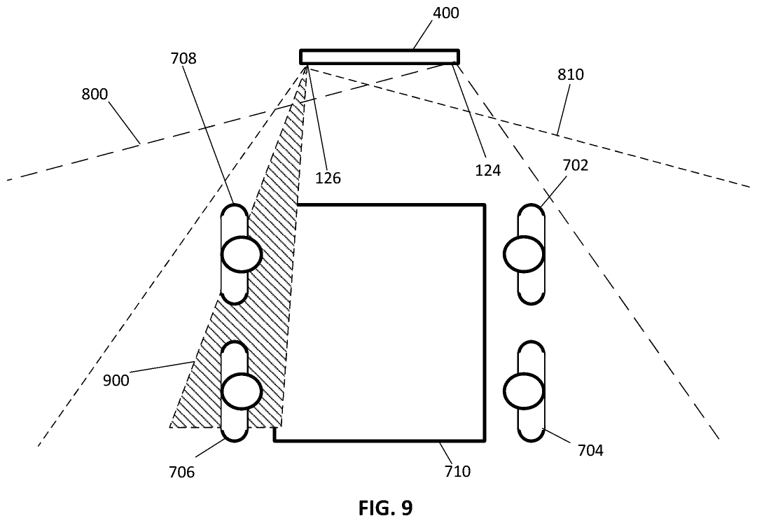

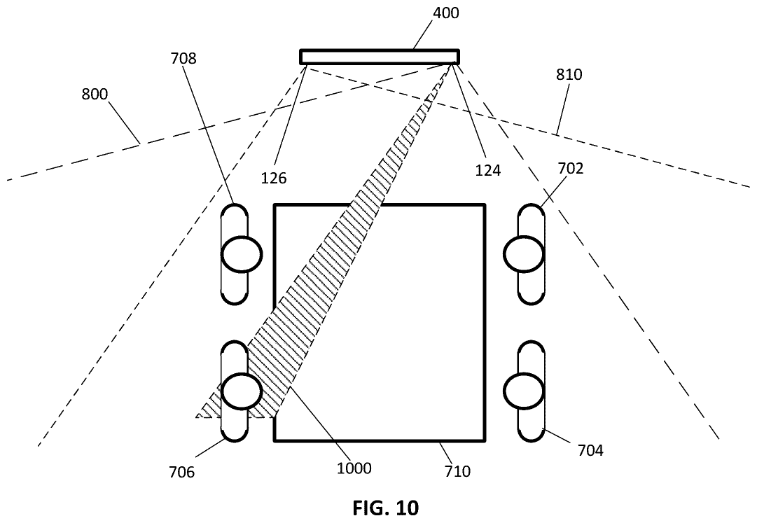

FIG. 8 is a diagram showing one example of the disclosed videobar 400 in an example videoconferencing environment. The environment may include four local participants 702, 704, 706, 708 seated around a table 710. In this example, the videobar 400 may have a camera 124 located at one end and a camera 126 located at an opposite end. The cameras 124, 126 may have independent fields of view 800, 810, respectively, that have their extents indicated by dotted lines in FIGS. 8-10. FIGS. 9 and 10 illustrate one of the advantages of having cameras at the ends of the videobar 400. As shown by the shaded portion 900 within the left camera's field of view 800 in FIG. 9, the view of participant 706 from the left camera 126 may be partially obscured by participant 708. However, as shown by the shaded portion 1000 within the right camera's field of view 810 in FIG. 10, the view of participant 706 from the right camera 124 may be unobscured.

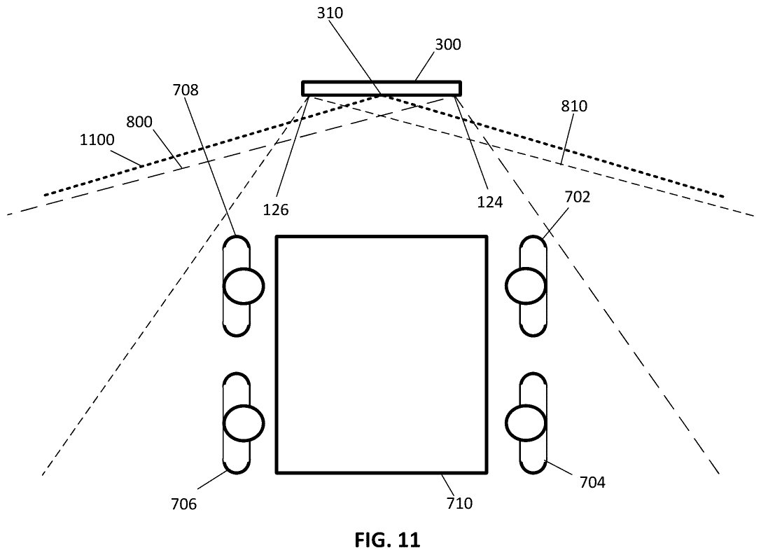

FIG. 11 illustrates another example videobar 300 in an example videoconferencing environment. The environment may include four local participants 702, 704, 706, 708 seated around a table 710. In this example, the videobar 300 may have three cameras 124, 126, 310, where camera 124 is located at one end, camera 126 is located at an opposite end, and camera 310 is located at the center. The cameras 124, 126, 310 may have independent fields of view 800, 810, 1100, respectively, that have their extents indicated by dotted lines in FIG. 11. In one example, the center camera 310 may have a wider field of view 1100 to capture the entire room while the end cameras 124, 126 may have more focused fields of view 800, 810.

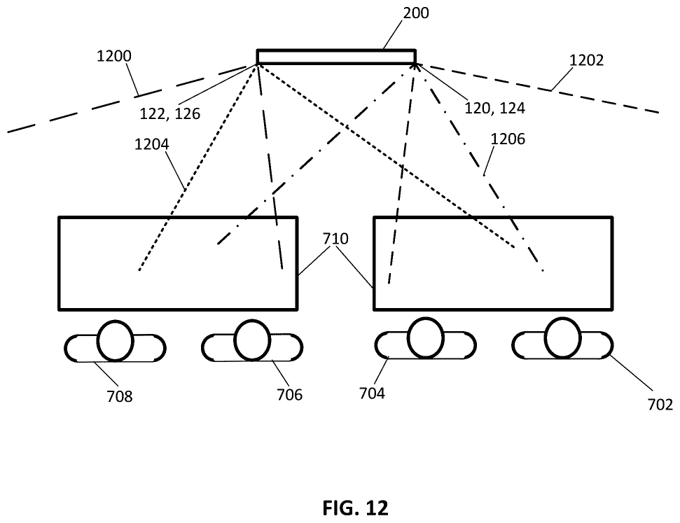

FIG. 12 illustrates another example videobar 200 in an example videoconferencing environment. The environment may include four local participants 702, 704, 706, 708 seated around a table 710. In this example, the videobar 200 may have four cameras 120, 122, 124, 126, where two cameras 120, 124 are located at one end and two cameras 122, 126 are located at an opposite end. The cameras 120, 122, 124, 126 may have independent fields of view 1200, 1202, 1204, 1206, respectively, that have their extents indicated by dotted lines in FIG. 12. In one example, the cameras 120, 122, 124, 126 may be identical, with identical view angles, but positioned along different axes to capture different portions of the room. Two cameras 120, 122 may be positioned so that their fields of view 1200, 1202 capture the periphery of the room, while the other two cameras 124, 126 may be positioned so that their fields of view 1204, 1206 capture a more centralized view of the room. In other examples, the cameras 120, 122, 124, 126 may have the same or different view angles, the same or different pixel densities, the same or different focal lengths, optical and/or digital zoom functions, and/or be electromechanically actuated to change their look direction.

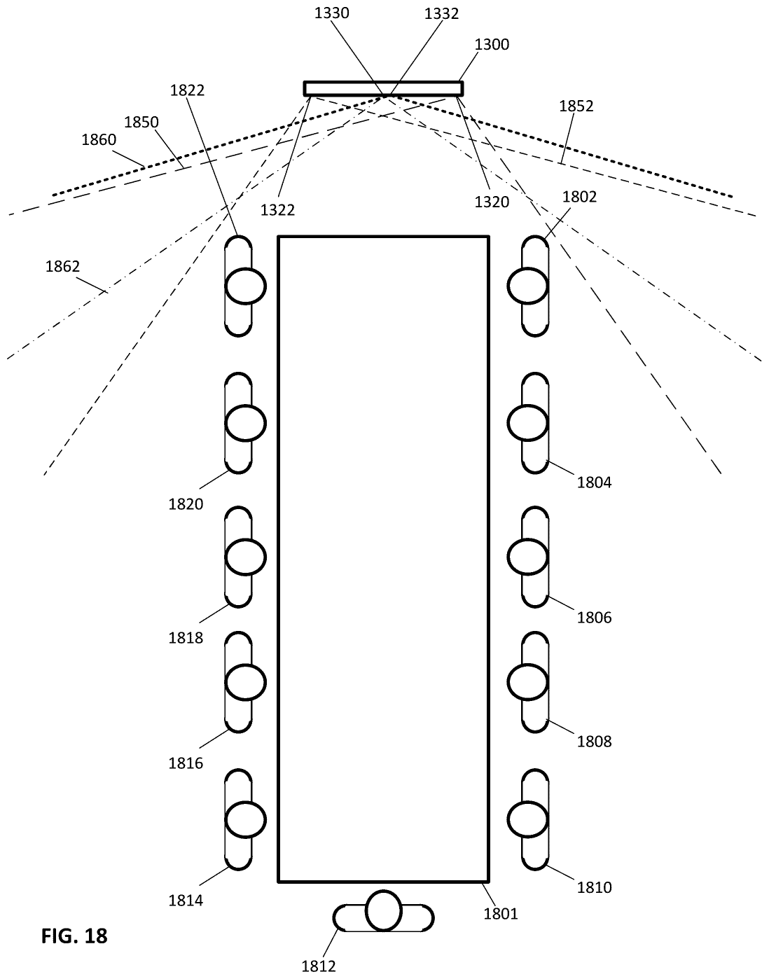

FIG. 18 illustrates a further example videobar 1300 in an example videoconferencing environment. The environment may include eleven local participants 1802, 1804, 1806, 1808, 1810, 1812, 1814, 1816, 1818, 1820, 1822 seated around a table 1801. In this example, the videobar 1300 may have four cameras, 1320, 1322, 1330, 1332, where camera 1320 is located at one end, camera 1322 is located at the other end, and cameras 1330, 1332 are located at the center of the videobar 1300. The cameras 1320, 1322, 1330, 1332 may have independent fields of view 1850, 1852, 1860, 1862, respectively, that have their extents indicated by dotted lines in FIG. 18. In one example, the center camera 1332 may have a wide angle lens with a relatively wide field of view 1860 to capture the entire room, while the center camera 1330 may have a telephoto lens with a narrower field of view 1862 that is more focused to capture the participants 1802, 1804, 1806, 1808, 1810, 1812, 1814, 1816, 1818, 1820, 1822 and the table 1801. In addition, the end cameras 1320, 1322 may have more focused fields of view 1850, 1852 that are directed inwardly towards the center of the videobar 1300, e.g., 30 degrees inward.

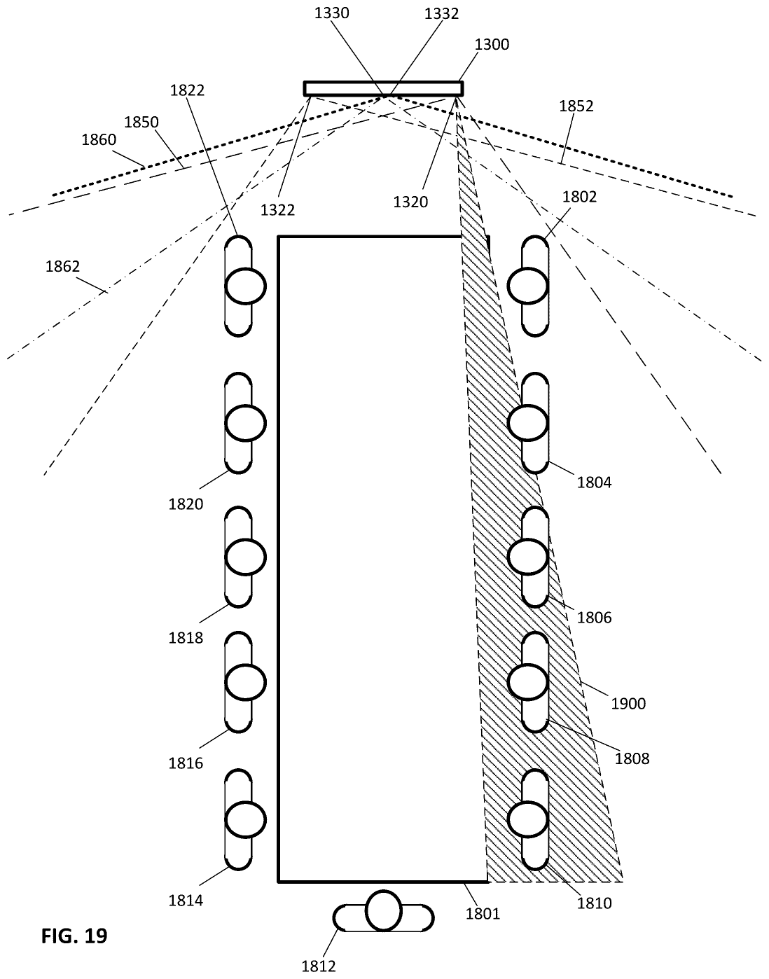

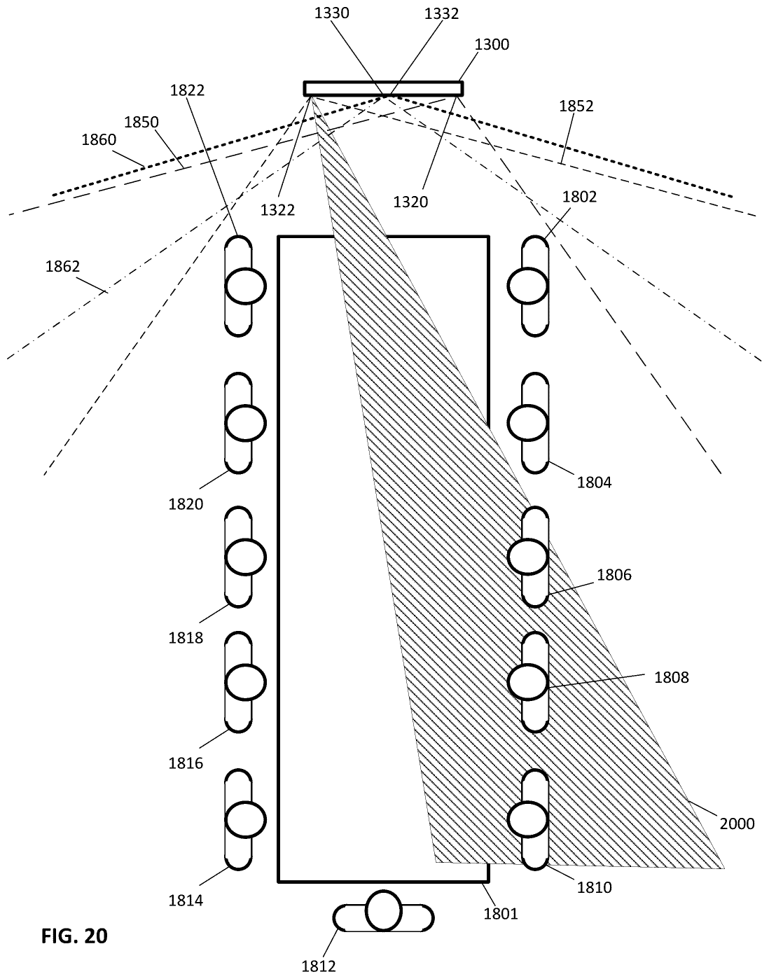

FIGS. 19 and 20 illustrate one of the advantages of having the cameras 1320, 1322 at the ends of the videobar 1300. As shown by the shaded portion 1900 within the right camera 1320's field of view 1850 in FIG. 19, the view of participants 1806, 1808, and 1810 may be partially obscured by participants 1802 and 1804. However, as shown by the shaded portion 2000 within the left camera 1322's field of view 1852 in FIG. 20, the view of participants 1806, 1808, and 1810 from the left camera 1322 may be unobscured.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A videoconferencing device comprising:
an elongated housing comprising a first end and a second end opposite of the first end;
a microphone array;
one or more loudspeakers; and
a plurality of cameras, wherein at least one camera of the plurality of cameras is disposed at the first end of the housing and at least another camera of the plurality of cameras is disposed at the second end of the housing.

2. The videoconferencing device of claim 1,
wherein the plurality of cameras comprises a first pair of substantially identical cameras;
wherein a first camera of the first pair of cameras is disposed at the first end of the housing and a second camera of the first pair of cameras is disposed at the second end of the housing; and
wherein the first camera and the second camera of the first pair of cameras are positioned symmetrically relative to each other and relative to a plane positioned substantially equidistant from the first and second ends of the housing.

3. The videoconferencing device of claim 2,
wherein the plurality of cameras further comprises a second pair of substantially identical cameras;
wherein a first camera of the second pair of cameras is disposed at the first end of the housing and a second camera of the second pair of cameras is disposed at the second end of the housing;
wherein the first camera and the second camera of the second pair of cameras are positioned symmetrically relative to each other and relative to the plane positioned substantially equidistant from the first and second ends of the housing; and
wherein the second pair of cameras differs from the first pair of cameras in at least one of: viewing angle, look direction, pixel density, focal length, optical zoom capability, and electromechanical actuation.

4. The videoconferencing device of claim 2, wherein a look direction of the first camera of the first pair of cameras intersects with a look direction of the second camera of the first pair of cameras.

5. The videoconferencing device of claim 4, wherein the look direction of the first camera of the first pair of cameras and the look direction of the second camera of the first pair of cameras intersect in front of the videoconferencing device and between the first and second cameras of the first pair of cameras.

6. The videoconferencing device of claim 3, wherein a look direction of the first camera of the first pair of cameras intersects with a look direction of the second camera of the first pair of cameras.

7. The videoconferencing device of claim 6, wherein the look direction of the first camera of the first pair of cameras and the look direction of the second camera of the first pair of cameras intersect in front of the videoconferencing device and between the first and second cameras of the first pair of cameras.

8. The videoconferencing device of claim 1, further comprising a camera disposed near a center of the housing.

9. The videoconferencing device of claim 1,
wherein the microphone array comprises a plurality of microphone sets arranged in a linear pattern relative to a first axis and configured to cover a plurality of frequency bands, each microphone set comprising a first microphone arranged along the first axis and a second microphone arranged along a second axis orthogonal to the first microphone,
wherein a distance between adjacent microphones along the first axis is selected from a first group consisting of whole number multiples of a first value, and wherein within each microphone set, a distance between the first and second microphones along the second axis is selected from a second group consisting of whole number multiples of a second value.

10. The videoconferencing device of claim 1, further comprising a plurality of processors, wherein at least one processor of the plurality of processors is in communication with and disposed proximate to the at least one camera and at least another processor of the plurality of processors is in communication with and disposed proximate to the at least another camera.

11. The videoconferencing device of claim 10, wherein the at least one processor or the at least another processor comprises at least one of a serializer or a deserializer.

12. A videoconferencing device comprising:
a microphone array disposed within an acoustical cavity;
at least one camera disposed outside of the acoustical cavity; and
at least one loudspeaker disposed outside of the acoustical cavity.

13. The videoconferencing device of claim 12, wherein the at least one camera comprises a camera disposed at a first end of the microphone array.

14. The videoconferencing device of claim 12, wherein the at least one loudspeaker comprises a loudspeaker disposed at a first end of the microphone array.

15. The videoconferencing device of claim 12, wherein the at least one camera comprises a camera disposed centrally relative to the microphone array.

16. The videoconferencing device of claim 12, wherein at least one of the at least one camera and at least one of the at least one loudspeaker are both disposed at a first end of the microphone array.

17. The videoconferencing device of claim 12,
wherein the at least one camera comprises a first pair of cameras and a second pair of cameras;
wherein a first camera of the first pair of cameras is disposed at a first end of the microphone array and a second camera of the first pair of cameras is disposed at a second end of the microphone array; and
wherein a first camera of the second pair of cameras is disposed at the first end of the microphone array and a second camera of the second pair of cameras is disposed at the second end of the microphone array.

18. The videoconferencing device of claim 17, wherein a look direction of the first camera of the first pair of cameras intersects with a look direction of the second camera of the first pair of cameras.

19. The videoconferencing device of claim 18, wherein the look direction of the first camera of the first pair of cameras and the look direction of the second camera of the first pair of cameras intersect in front of the videoconferencing device and between the first and second cameras of the first pair of cameras.

20. The videoconferencing device of claim 17, wherein the at least one loudspeaker comprises a first loudspeaker disposed at the first end of the microphone array and a second loudspeaker disposed at the second end of the microphone array.

21. The videoconferencing device of claim 12, wherein the acoustical cavity comprises an angled back plane.
